(19) United States
(12) Patent Application Publication
(10) Pub. No.: US 2018/0051744 A1
(43) Pub. Date: Feb. 22, 2018

(54) BEARING DEVICE OF AN EXHAUST GAS TURBOCHARGER

(71) Applicant: Bosch Mahle Turbo Systems GmbH & Co. KG, Stuttgart (DE)

(72) Inventors: Volkhard Ammon, Pliezhausen (DE); Ruediger Kleinschmidt, Besigheim (DE); Michal Klusacek, Praha (CZ); Oliver Kuhne, Stuttgart (DE); Steffen Schmitt, Ditzingen (DE); Frieder Stetter, Stuttgart (DE)

(21) Appl. No.: 15/678,074

(22) Filed: Aug. 15, 2017

(30) Foreign Application Priority Data
Aug. 16, 2016 (DE) DE102016215275.0

(51) Int. Cl. F16C 19/18; F16C 35/067; F01D 25/16; F01D 25/18

(52) U.S. Cl. CPC F16C 19/184; F16C 35/067; F01D 25/162; F05D 2240/50; F16C 2360/24; F05D 2220/40; F01D 25/186

(57) ABSTRACT

A bearing device of an exhaust gas turbocharger may include a bearing bush for mounting a shaft in a bearing housing. A pin may engage radially from a hub of the bearing housing into the bearing bush to provide a position securing device of the bearing bush at least against rotational movement. The pin and the bearing bush may be mounted on one another via at least one curved bearing surface, for example a spherical bearing surface and/or a convex bearing surface.

### CROSS-REFERENCE TO RELATED APPLICATION

This application claims priority to German patent application DE 10 2016 215 275.0 filed on Aug. 16, 2016, the contents of which are hereby incorporated by reference in its entirety.

### TECHNICAL FIELD

The present invention relates to a bearing device of an exhaust gas turbocharger, in particular for motor vehicle engines, for mounting a shaft in a bearing housing. The invention, furthermore, relates to an exhaust gas turbocharger having such a bearing device.

### BACKGROUND

From DE 10 2006 055 415 A1 a generic bearing device of an exhaust gas turbocharger for mounting a common turbine/compressor shaft in a hub formed by a housing of the exhaust gas turbocharger and located between the turbine and compressor wheel via a bearing bush floatingly mounted equally relative to the hub and the shaft within this hub. Here, a bearing region is provided, in which on the one hand between hub and bearing bush a hub angular duct and on the other hand between bearing bush and shaft a shaft ring duct are present, wherein the two annular ducts communicate with one another. By way of a pin which radially engages from the hub in the bearing bush a position securing device of the bearing bush is additionally provided, wherein the radial pin engages through the hub ring duct. It is provided, furthermore, that the pin is designed as an oil feed duct communicating with the shaft and/or hub ring duct and thereby is to simplify the production of the bearing device.

From DE 30 05 873 A1 a bearing structure for fast-turning shafts is known, having a housing, a bore running through the same and a radial sleeve bearing arranged in the bore with opposing ends, which extent beyond the bore. Anchorage means of the sleeve bearing in this case have a high pin, which can absorb pressure and thrust loads. Furthermore, the sleeve bearing absorbs any thrust on the shaft so that its axial displacement is limited.

Generally, bearing bushes of bearing devices in the case of exhaust gas turbochargers have to be very precisely clamped in in axial direction, but remain freely moveable in a plane that is perpendicular thereto and be additionally tiltable about a bearing centre in order to be able to offset certain movements.

Disadvantageous with the bearing bushes known from the prior art and the pins fixing the same however is that although these make possible fixing the bearing bush in axial direction, however do not offer any tilting possibility and thereby increase a bearing friction.

### SUMMARY

The present invention therefore deals with the problem of stating an improved or at least an alternative embodiment for a bearing device of the generic type, which in particular overcomes the disadvantages known from the prior art.

According to the invention, this problem is solved through the subject of the independent Claim(s). Advantageous embodiments are subject of the dependent claims.

The present invention is based on the general idea of mounting a bearing bush in a hub of a bearing device via a type of ball joint and because of this bring about a fixing in axial direction and also make possible a tilting of the bearing bush. The bearing device of an exhaust gas turbocharger according to the invention for mounting a shaft in a bearing housing of the exhaust gas turbocharger in this case comprises a hub receiving the shaft, in which the bearing bush is arranged. At least against rotation, the bearing bush in this case is secured by a pin engaging from the hub radially into the bearing bush. According to the invention, the pin and the bearing bush are now mounted on one another via at least one bearing surface that is spherically or convexly curved. Here it is obviously conceivable that on the pin a convex bearing surface and on the bearing bush a concave bearing surface that is designed complementarily thereto can be arranged or that exclusively on the pin or on the bearing bush such a convexly curved bearing surface is provided. However, all embodiments have in common that the pin prevents both a rotation and also an axial displacement of the bearing bush, however makes possible a tilting of the same without canting and thereby possibly a jamming of the pin relative to the bearing bush occurring. Through the tilting possibility of the bearing bush, the bearing friction can be reduced, the economy of the exhaust gas turbocharger increased and simultaneously a substantial contribution made for the wear and noise reduction. The technical embodiment of the spherical or convex region, i.e. of the curved bearing surface, can for example be effected via a rolling bearing ball which is placed into a chamfer or spherical trough on the bearing bush and/or on the pin. The chamfers can also be formed by stamping the ball so that they become spherical on the contact surfaces. In particular with soft materials, the edge of a chamfer can be formed by means of a ball and a press so that the ball radius is depicted there. This is advantageous in the case of ball valves in order to stamp the sealing seat and thus reduce a leakage.

In an advantageous further development of the solution according to the invention, a ball is arranged between a longitudinal end of the pin facing the bearing bush and the bearing bush. By way of such a ball and a spherical trough formed on an outer cylindrical surface of the bearing bush complementarily thereto, an areal mounting of the two components on one another can be achieved namely independently of the tilting angle of the bearing bush relative to the pin.

In an advantageous further development of the solution according to the invention, the ball is designed as a separate component or unitarily with the pin. Both embodiments offer advantages, wherein in particular the unitary design of the ball with the pin, i.e. the integration of the ball in the pin, makes possible a reduction of the component number and thus also a reduction of the stock keeping and logistics costs as well as the assembly costs. Purely theoretically it is obviously also conceivable that the ball can be formed as a separate component, as a result of which in particular an increased flexibility with respect to the production of the bearing device according to the invention can be achieved.

In a further advantageous embodiment of the solution according to the invention, the pin has two parts, namely a first part that is connected to the bearing housing in a fixed manner, in particular pressed into the same and a second part which is slidingly mounted in a pin duct of the bearing housing of the exhaust gas turbocharger. Between both parts a spring device is arranged, in particular a disc spring or a corrugated spring, which preloads the second part against the bearing bush. Because of this, bearing characteristics that remain the same can be achieved in particular. In particular the design of the spring device as disc spring makes possible high preload forces with small spring travel at the same time.

In a further advantageous embodiment of the solution according to the invention, the pin is formed hollow and simultaneously serves as oil feed. In this embodiment, the pin simultaneously fulfils two objectives, namely on the one hand the objective of lubricating the bearing bush and on the other hand the objective of fixing the same in the hub. Through this function integration of two different functions in the pin, further components are no longer required, as a result of which the number of parts can be reduced. Alternatively, it is obviously also conceivable that the pin is formed solid, which brings with it the major advantage of simple and thus also more cost-effective production but on the other hand requires a separate oil feed to the bearing bush.

The present invention furthermore is based on the general idea of equipping an exhaust gas turbocharger with a previously described bearing device and because of this make possible a mounting of a bearing bush in a bearing housing and thus of a shaft in the bearing bush that is reliable on the one hand but also cost-effective and optimal on the other hand. The improved mounting through the tilting possibility of the bearing bush reduces the bearing friction and thereby increases the economy of the exhaust gas turbocharger.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference characters relate to same or similar or functionally same components.

### BRIEF DESCRIPTION OF THE DRAWINGS

There it shows, in each case schematically,

FIG. 1 a sectional representation through a bearing device according to the invention of an exhaust gas turbocharger according to the invention,

FIG. 2 a representation as in FIG. 1, however with a differently configured bearing device,

FIG. 3 a bearing device according to the invention with a solid pin.

### DETAILED DESCRIPTION

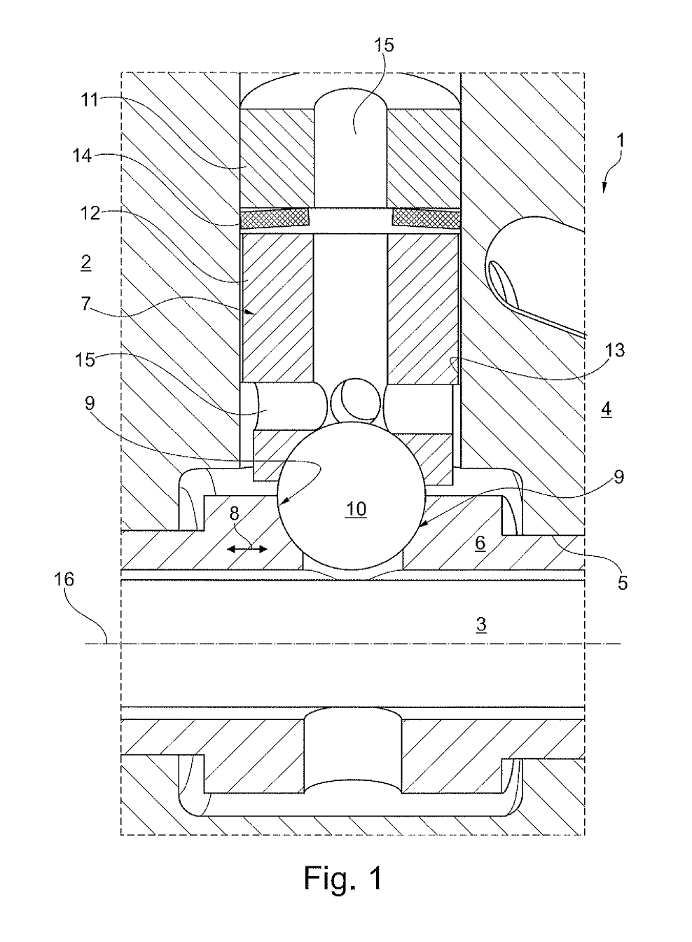

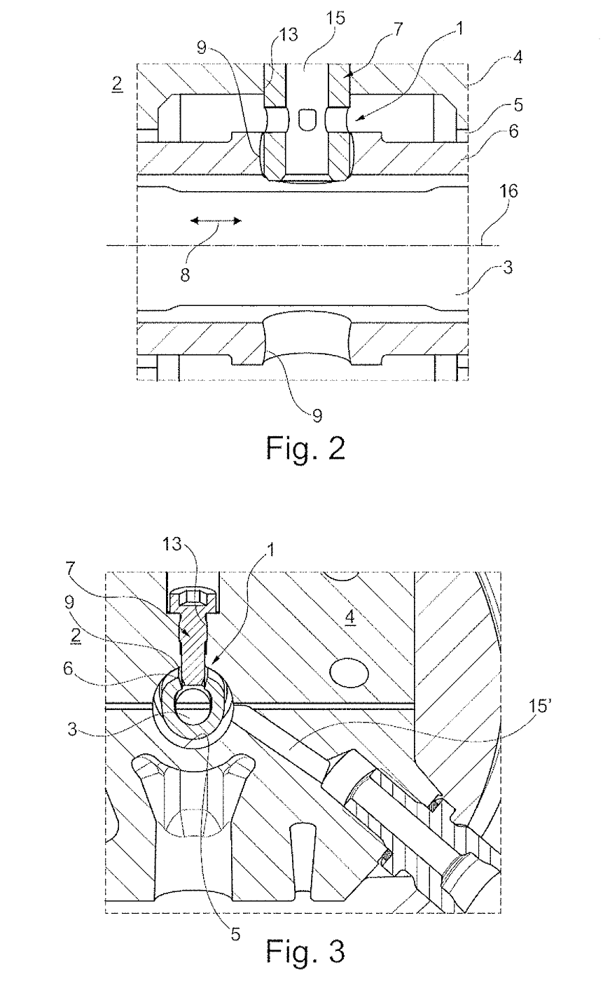

According to FIGS. 1 to 3, a bearing device 1 according to the invention of an exhaust gas turbocharger 2, in particular for motor vehicle engines, for mounting a shaft 3 in a bearing housing 4 has a bearing bush preferentially floatingly mounted axially and against rotation within a hub 5. In the bearing device 1, a position securing device of the bearing bush 6 at least against rotation, but also against a movement in axial direction 8 is provided through a bearing pin radially engaging from the hub 5 into the bearing bush 6 which can also be described as fastening pin 7. According to the invention, the pin 7 and the bearing bush 6 are now mounted on one another via a spherically curved bearing surface 9 (see FIG. 1) or a convexly curved bearing surface 9 (see FIGS. 2 and 3). As shown in FIG. 1, the curved bearing surface 9 can be arranged either directly or indirectly on the pin 7 and also on the bearing bush 6 or as shown in FIG. 2, exclusively on the pin 7 or exclusively on the bearing bush 6.

Looking at FIG. 1, it is evident that between a longitudinal end of the pin 7 facing the bearing bush 6 and the bearing bush 6 a ball 10 is arranged, so that there is a type of ball joint between the bearing bush 6 and the pin 7. The ball 10 in this case can be designed as a separate component or be produced unitarily with the pin 7. According to FIG. 1, a bearing surface 9 that is complementary to the ball 10 can be provided on the bearing bush 6, which makes possible a tilting of the bearing bush 6 relative to the axial direction 8 at least to a certain extent, but fixes the bearing bush 6 in axial direction.

Looking at the embodiment of the bearing device 1 according to the invention according to FIG. 1 further, it is evident that the pin 7 has two parts 11 and 12, namely a first part 11 that is connected to the bearing housing 4 in a fixed manner, in particular pressed together with the same and a second part 12 that is slidingly mounted in a pin duct 13. Between the two parts 11, 12 a spring device 14 is arranged, which preloads the second part 12 against the bearing bush 6 and in the process supports itself on the first part 11. The spring device 14 in this case can for example be designed as disc spring or as a corrugated spring. Both mentioned spring types however are purely exemplary and make possible comparatively high spring forces over a comparatively short spring travel. By way of the spring device 14, an optimum mounting of the bearing bush 6 via the spherically or convexly curved bearing surface 9 be made possible in particular in the long term.

Looking at FIGS. 1 and 2 further, it is evident that the pin 7 is designed hollow and because of this simultaneously assumes the function of an oil feed and makes available an oil duct 15 in the interior. Compared with this, the pin 7 according to FIG. 3 is designed solid so that in this case the oil feed to the bearing bush 6 takes place via a separate oil duct 15′. At the same time, the pin 7 represented according to FIG. 3 can be screwed into the pin duct 13 via a thread.

Looking at FIG. 2 once more it is evident that on the pin 7 a convex bearing surface 9 is formed, while in the lower image half of FIG. 2 the convexly curved bearing surface 9 is arranged in the region of the bearing bush 6. Preferentially, bearing surfaces 9 which are formed complementarily to one another are provided both on the pin 7 and also on the bearing bush 6, wherein however merely one spherically or convexly curved bearing surface 9 exclusively on the pin 7 or on the bearing bush 6 is adequate for realising the idea according to the invention.

All shown embodiments have in common that by way of the spherically or convexly curved bearing surface 9 the pin 7 and the bearing bush 6 are fixed on one another in axial direction but are tiltably mounted about an axis 16 relative to one another, as a result of which an angle compensation function can be created, which makes a substantial contribution to reducing wear and noise.

1. A bearing device of an exhaust gas turbocharger, comprising:
a bearing bush for mounting a shaft in a bearing housing, the bearing bush mounted within a hub;
a pin radially engaging from the hub into the bearing bush providing a position securing device of the bearing bush at least against rotation; and
wherein the pin and the bearing bush are mounted on one another via at least one of a spherical bearing surface and a convex bearing surface.

2. The bearing device according to claim 1, further comprising a ball arranged between a longitudinal end of the pin facing the bearing bush and the bearing bush.

3. The bearing device according to claim 2, wherein the ball is coupled as a separate component to the pin.

4. The bearing device according to claim 2, wherein the bearing bush has a counter bearing surface that is provided complementary to the ball.

5. The bearing device according to claim 1, wherein the pin includes a first part fixedly connected to the bearing housing and a second part slidingly mounted in a pin duct of the bearing housing.

6. The bearing device according to claim 5, further comprising a spring device arranged between the first part and the second part, wherein the second part is preloaded against the bearing bush via the spring device.

7. The bearing device according to claim 6, wherein the spring device is disc spring.

8. The bearing device according to claim 1, wherein the at least one of the spherical bearing surface and the convex bearing surface is provided exclusively on one of the pin and the bearing bush.

9. The bearing device according to claim 1,
wherein the pin is hollow for communicating oil.

10. An exhaust gas turbocharger, comprising:
a bearing device, the bearing device including:
a bearing housing defining a hub;
a bearing bush arranged in the hub for mounting a shaft in the bearing housing;
a pin radially engaging from the hub into the bearing bush for securing a position of the bearing bush against at least rotational movement and
wherein the pin and the bearing bush are mounted on one another via at least one of a convexly curved bearing surface and a spherically curved bearing surface.

11. The exhaust gas turbocharger according to claim 10, further comprising a rolling bearing ball arranged between the bearing bush and a longitudinal end of the pin facing the bearing bush.

12. The exhaust gas turbocharger according to claim 10, wherein the pin includes a first part fixedly connected to the bearing housing and a second part slidingly mounted in a pin duct of the bearing housing; and
the bearing device further including a spring device arranged between the first part and the second part of the pin, wherein the second part is preloaded against the bearing bush via the spring device.

13. The bearing device according to claim 1, wherein the pin is solid.

14. The bearing device according to claim 2, wherein the ball is provided unitarily with the pin.

15. The bearing device according to claim 2, wherein the ball defines the at least one of the spherical bearing surface and the convex bearing surface, and wherein at least one of the bearing bush and the pin has a concave bearing surface interacting with the ball.

16. The bearing device according to claim 5, wherein the first part of the pin is press fitted together with the bearing housing.

17. The bearing device according to claim 6, wherein the spring device is a corrugated spring.

18. A bearing device of an exhaust gas turbocharger, comprising:
a bearing housing defining a hub;
a bearing bush arranged in the hub for mounting a shaft in the bearing housing;
a pin radially engaging from the hub into the bearing bush for securing a position of the bearing bush against at least rotational movement; and
wherein the pin and the bearing bush are mounted on one another via at least one curved bearing surface.

19. The bearing device according to claim 18, wherein the at least one curved bearing surface has a convexly curved shape.

20. The bearing device according to claim 18, wherein the at least one curved bearing surface has a spherically curved shape.
